(19) United States
(12) Patent Application Publication
(10) Pub. No.: US 2020/0070517 A1
(43) Pub. Date: Mar. 5, 2020

(54) LIQUID EJECTING APPARATUS AND MAINTENANCE METHOD FOR LIQUID EJECTING APPARATUS

(71) Applicant: SEIKO EPSON CORPORATION, Tokyo (JP)

(72) Inventors: Hisashi SATO, Shiojiri-Shi (JP); Kazuyuki FUJIOKA, Matsumoto-shi (JP); Yuichi URABE, Shiojiri-Shi (JP); Hiroyuki ITO, Matsumoto-shi (JP)

(21) Appl. No.: 16/550,861

(22) Filed: Aug. 26, 2019

(30) Foreign Application Priority Data
Aug. 29, 2018 (JP) 2018-160476

(51) Int. Cl. B41J 2/14; B41J 2/055

(52) U.S. Cl. CPC B41J 2/14233; B41J 2/055; B41J 2002/14419; B41J 2002/14491; B41J 2002/14241

(57) ABSTRACT

A liquid ejecting apparatus includes a liquid supply flow path configured to supply a liquid stored in a liquid supply source to a liquid ejecting portion, a reservoir portion provided in the liquid supply flow path, an on-off valve provided between the liquid supply source and the reservoir portion, a discharge mechanism configured to discharge the liquid in the liquid supply flow path by depressurizing the liquid supply flow path, and a pressure mechanism configured to apply a negative pressure to the interior of the reservoir portion from the exterior. A negative pressure equal to or larger than a negative pressure applied to the interior of the reservoir portion by the discharge mechanism, is applied to the interior of the reservoir portion in a maintenance operation in which the liquid supply flow path is depressurized by the discharge mechanism while the on-off valve is closed.

The present application is based on, and claims priority from JP Application Serial Number 2018-160476, filed Aug. 29, 2018, the disclosure of which is hereby incorporated by reference herein in its entirety.

### BACKGROUND

### 1. Technical Field

The present disclosure relates to a liquid ejecting apparatus such as an ink jet printer, and a maintenance method for a liquid ejecting apparatus.

### 2. Related Art

JP-A-2002-1992 discloses a recording apparatus including a recording head for ejecting a liquid supplied from a supply source through a supply path, a sub-tank for storing the liquid between the supply source and the recording head, a valve mechanism for opening and closing the supply path, and a depressurization mechanism for depressurizing the supply path, as an example of a liquid ejecting apparatus.

In such a recording apparatus, in order to discharge bubbles, foreign objects, and the like in the supply path, the depressurization mechanism may perform a depressurizing operation in a state where the valve mechanism is closed, and then the valve mechanism may be opened to discharge the liquid from the supply path. At this time, the liquid in the sub-tank may be discharged by the depressurization of the depressurization mechanism. In a case where a large amount of liquid in the sub-tank is discharged by the depressurization of the depressurization mechanism, the amount of liquid consumption involved in maintenance is increased.

### SUMMARY

A liquid ejecting apparatus for solving the above problem includes a liquid ejecting portion configured to eject a liquid through a nozzle; a liquid supply flow path configured to supply the liquid stored in a liquid supply source to the liquid ejecting portion; a reservoir portion provided in the liquid supply flow path and configured to store the liquid; an on-off valve provided on a side of the liquid supply source relative to the reservoir portion in the liquid supply flow path and configured to open and close the liquid supply flow path; a discharge mechanism configured to discharge the liquid in the liquid supply flow path from a side of the liquid ejecting portion relative to the reservoir portion in the liquid supply flow path by depressurizing the liquid supply flow path; a pressure mechanism configured to apply a negative pressure to an interior of the reservoir portion from exterior; and a control portion configured to control the pressure mechanism to apply, to the interior of the reservoir portion, a negative pressure equal to or larger than a negative pressure applied to the interior of the reservoir portion by the depressurization of the discharge mechanism in a maintenance operation in which the liquid supply flow path is depressurized by the discharge mechanism while the liquid supply flow path being closed by the on-off valve.

A maintenance method for a liquid ejecting apparatus for solving the above problem is a maintenance method for the liquid ejecting apparatus that includes a liquid ejecting portion configured to eject a liquid through a nozzle; a liquid supply flow path configured to supply the liquid stored in a liquid supply source to the liquid ejecting portion; a reservoir portion provided in the liquid supply flow path and configured to store the liquid; an on-off valve provided on a side of the liquid supply source relative to the reservoir portion in the liquid supply flow path and configured to open and close the liquid supply flow path; and a discharge mechanism configured to discharge the liquid in the liquid supply flow path from a side of the liquid ejecting portion relative to the reservoir portion in the liquid supply flow path by depressurizing the liquid supply flow path. The method includes applying, to an interior of the reservoir portion, a negative pressure equal to or larger than a negative pressure applied to the interior of the reservoir portion by the depressurization of the discharge mechanism in a maintenance operation in which the liquid supply flow path is depressurized by the discharge mechanism while the liquid supply flow path being closed by the on-off valve.

### BRIEF DESCRIPTION OF THE DRAWINGS

FIG. 1 is a perspective view illustrating an embodiment of a liquid ejecting apparatus.

FIG. 2 is a side view schematically illustrating an internal structure of a liquid ejecting apparatus.

FIG. 3 is a schematic diagram illustrating a configuration of the liquid ejecting apparatus and a liquid supply device.

FIG. 4 is a cross-sectional view illustrating a reservoir portion and a pressure mechanism.

FIG. 5 is a cross-sectional view taken along a line V-V in FIG. 4.

FIG. 6 is a cross-sectional view illustrating a modification of the reservoir portion.

FIG. 7 is a cross-sectional view illustrating another modification of the reservoir portion.

FIG. 8 is a schematic diagram illustrating a modification of the liquid ejecting apparatus.

FIG. 9 is a schematic diagram illustrating another modification of the liquid ejecting apparatus.

### DESCRIPTION OF EXEMPLARY EMBODIMENTS

Hereinafter, an embodiment of a liquid ejecting apparatus will be described with reference to the accompanying drawings. The liquid ejecting apparatus is, for example, an ink jet printer configured to print an image such as characters or photographs by ejecting ink, which is an example of a liquid, onto a medium such as a paper sheet.

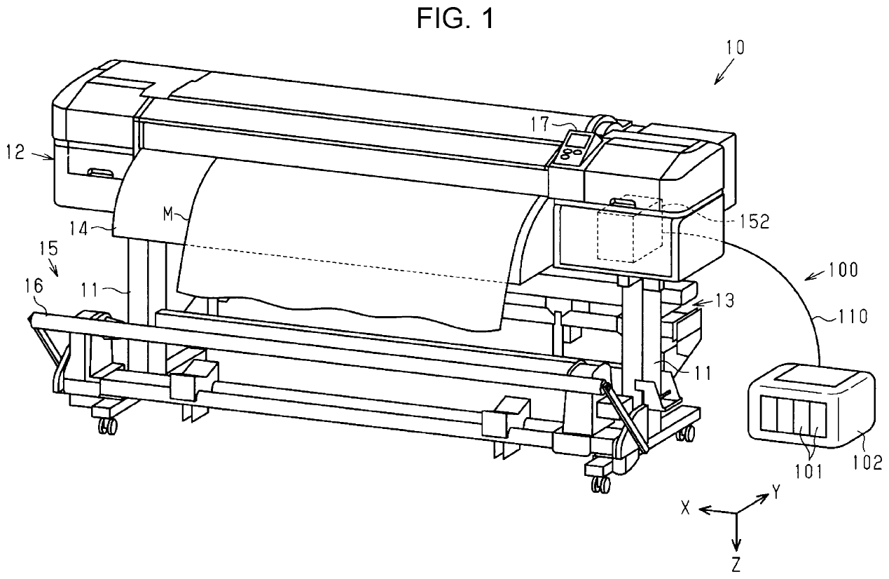

As illustrated in FIG. 1, a liquid ejecting apparatus 10 includes a pair of leg portions 11 and a housing 12 mounted on the leg portions 11. The liquid ejecting apparatus 10 includes a feeding portion 13 configured to feed out a medium M wound on a roll body into the housing 12, a guide portion 14 configured to guide the medium M discharged from the housing 12, and a winding portion 15 configured to wind the medium M guided by the guide portion 14 onto a roll body. The liquid ejecting apparatus 10 includes a tension applying mechanism 16 configured to give tension to the medium M to be wound by the winding portion 15, and an operation panel 17 to be operated by a user.

The liquid ejecting apparatus 10 has predetermined lengths as its width, depth, and height in a state of being installed at a place where it is used. The direction of gravity is indicated by a Z-axis, assuming that the liquid ejecting apparatus 10 is disposed on a horizontal plane. At this time, the width direction and the depth direction of the liquid ejecting apparatus 10 are substantially horizontal. The depth direction of the liquid ejecting apparatus 10 is indicated by a Y-axis. The width direction of the liquid ejecting apparatus 10 is indicated by an X-axis intersecting with the Y-axis and the Z-axis. Therefore, the X-axis, the Y-axis, and the Z-axis are coordinate axes indicating the width, depth, and height, respectively.

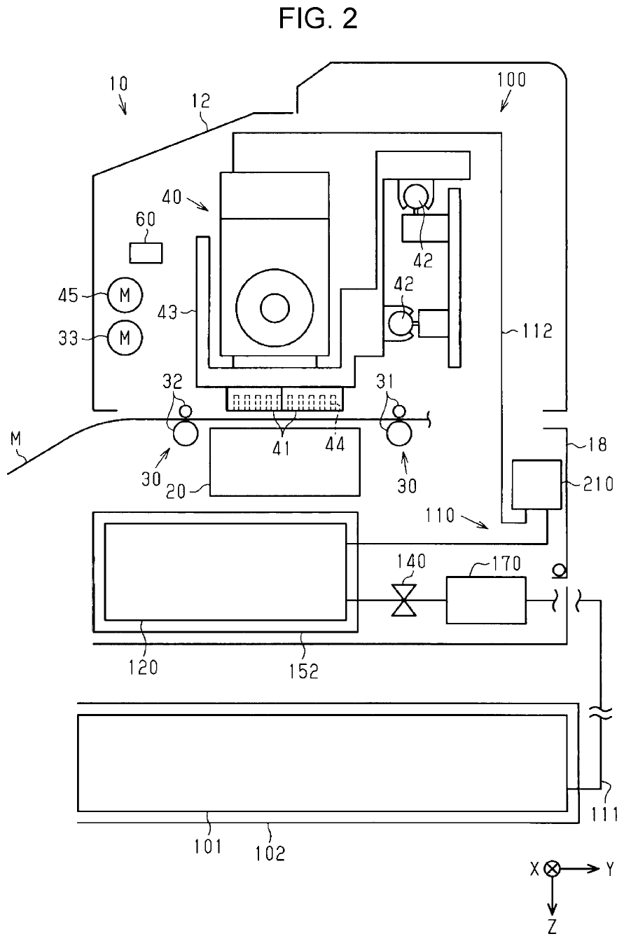

As illustrated in FIG. 2, the liquid ejecting apparatus 10 includes a support base 20 for supporting the medium M, and a transportation portion 30 for transporting the medium M. The liquid ejecting apparatus 10 includes a printing portion 40 configured to perform printing on the medium M, and a control portion 60 configured to control operations of the liquid ejecting apparatus 10. The liquid ejecting apparatus 10 is provided with a liquid supply device 100 configured to supply a liquid to the printing portion 40. The control portion 60 is configured to include, for example, a CPU, a memory, and the like. The control portion 60 controls the liquid ejecting apparatus 10 and the liquid supply device 100 by the CPU executing a program stored in the memory.

The support base 20 is so provided as to extend in the width direction. In the present embodiment, the width direction of the liquid ejecting apparatus 10 is coincident with the width direction of the medium M. The medium M is transported in a direction opposite to the depth direction on the support base 20. Therefore, the transportation direction of the medium M is opposite to the depth direction.

The transportation portion 30 includes a pair of transportation rollers 31 located on a deep side relative to the support base 20 in the depth direction, and a pair of transportation rollers 32 located on a front side relative to the support base 20. The transportation portion 30 is provided with a transportation motor 33 for driving the pair of transportation rollers 31 and the pair of transportation rollers 32. When the pair of transportation rollers 31 and the pair of transportation rollers 32 are driven by the transportation motor 33, the medium M pinched between the pair of transportation rollers 31 and between the pair of transportation rollers 32 is transported in the transportation direction along a surface of the support base 20.

The printing portion 40 includes a liquid ejecting portion 41 configured to eject a liquid through a nozzle 44. The printing portion 40 of the present embodiment includes a guide shaft 42 provided in such a manner as to extend in the width direction, and a carriage 43 configured to reciprocate in the width direction by being guided by the guide shaft 42.

The printing portion 40 is provided with a carriage motor 45 for moving the carriage 43 along the guide shaft 42. The carriage 43 is moved in accordance with the driving of the carriage motor 45. That is, the liquid ejecting apparatus 10 of the present embodiment is a serial type apparatus in which the liquid ejecting portion 41 scans with respect to the medium M. The liquid ejecting apparatus 10 may be configured as a line type apparatus in which the liquid ejecting portion 41 is provided having a long size in the width direction.

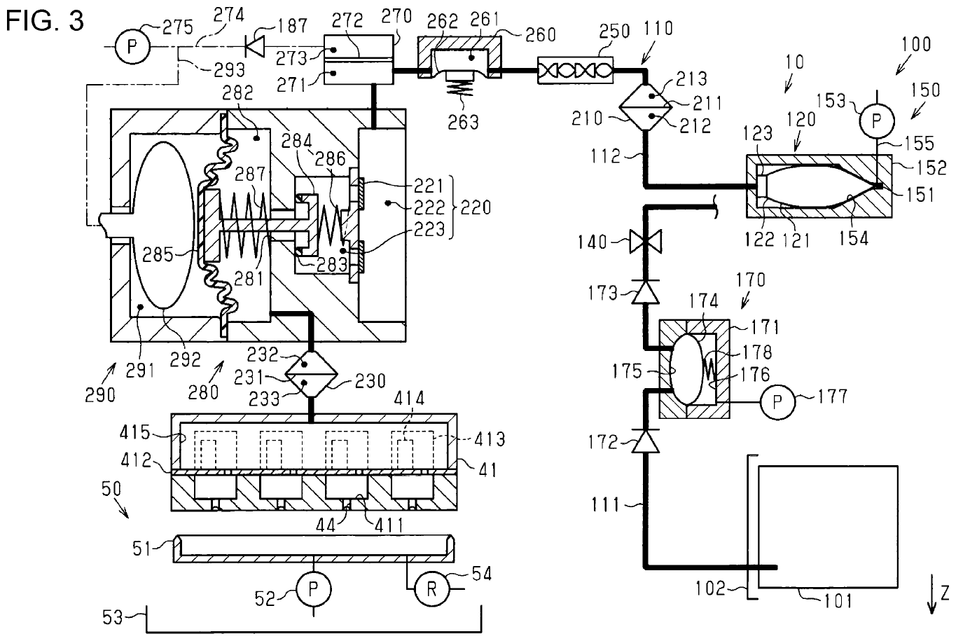

As illustrated in FIG. 3, the liquid ejecting portion 41 includes one or a plurality of nozzles 44 for ejecting the liquid. The liquid ejecting portion 41 includes an individual liquid chamber 411 communicating with the nozzle 44, an accommodation portion 413 separated by a vibration plate 412 from the individual liquid chamber 411, and an actuator 414 accommodated in the accommodation portion 413. The liquid ejecting portion 41 is provided with a common liquid chamber 415 for temporarily storing the supplied liquid and supplying the liquid to a plurality of individual liquid chambers 411.

The actuator 414 is, for example, a piezoelectric element configured to contract when a drive voltage is applied thereto. The vibration plate 412 is deformed due to the contraction of the actuator 414, and thereafter, when the application of the drive voltage is stopped, the liquid in the individual liquid chamber 411 whose volume has been changed is ejected as a droplet through the nozzle 44.

The liquid ejecting apparatus 10 includes a liquid supply flow path 110, a reservoir portion 120, an on-off valve 140, and a pressure mechanism 150 as constituent elements of the liquid supply device 100. The liquid supply flow path 110 is configured to supply a liquid stored in a liquid supply source 101 to the liquid ejecting portion 41. The liquid supply flow path 110 connects the liquid ejecting portion 41 to the liquid supply source 101 serving as a liquid supply source to the liquid ejecting portion 41. The liquid supply flow path 110 is configured to include, for example, a tube.

The reservoir portion 120 is configured to store a liquid. The reservoir portion 120 is provided in the liquid supply flow path 110. The reservoir portion 120 is located between the liquid supply source 101 and the liquid ejecting portion 41 in the liquid supply flow path 110. The reservoir portion 120 stores the liquid supplied from the liquid supply source 101. Therefore, the reservoir portion 120 is located downstream of the liquid supply source 101 in the direction in which the liquid is supplied.

The reservoir portion 120 may be formed of a flexible member 121. The reservoir portion 120 of the present embodiment includes a bag body 122 formed of the flexible member 121 having flexibility, and a connection body 123 connected to the liquid supply flow path 110. The liquid supplied from the liquid supply source 101 is stored in the bag body 122 through the connection body 123. The bag body 122 is inflated or deflated in accordance with the amount of liquid stored. That is, the volume of the bag body 122 changes by inflating or deflating.

The reservoir portion 120 is configured to store a predetermined amount or more than a predetermined amount of liquid while the liquid is supplied from the liquid supply source 101. The predetermined amount is an amount that is expected to be used for printing one image. With this, even if the liquid in the liquid supply source 101 is exhausted during the printing of an image, the printing of the image can be continued by using the liquid stored in the reservoir portion 120. This reduces the risk of interruption of printing. Further, it is possible to suppress deterioration in print quality such as color unevenness due to the interruption of printing.

When the remaining amount of liquid stored in the liquid supply source 101 comes to be 0 or small, a liquid is supplied to the liquid ejecting portion 41 from the reservoir portion 120. Therefore, while the liquid stored in the liquid supply source 101 is sufficient in amount, the amount of liquid stored in the reservoir portion 120 hardly changes. When the amount of liquid stored in the liquid supply source 101 becomes small, the amount of liquid stored in the reservoir portion 120 starts to decrease. In the reservoir portion 120 of the present embodiment, when the bag body 122 is inflated to its maximum, a predetermined amount or more than a predetermined amount of liquid is stored.

In the present embodiment, the liquid is supplied to the reservoir portion 120 by being pressurized from the liquid supply source 101 side. Therefore, while the liquid stored in the liquid supply source 101 is sufficient in amount, the bag body 122 is maintained in an inflated state by being pressurized from the upstream. As a result, the reservoir portion 120 stores a predetermined amount or more than a predetermined amount of liquid while the liquid is supplied from the liquid supply source 101.

The on-off valve 140 is configured to open and close the liquid supply flow path 110. The on-off valve 140 is provided in the liquid supply flow path 110. The on-off valve 140 is provided on the liquid supply source 101 side relative to the reservoir portion 120 in the liquid supply flow path 110. Therefore, the on-off valve 140 is located between the reservoir portion 120 and the liquid supply source 101 in the liquid supply flow path 110. When the on-off valve 140 is opened, it is possible for the liquid to flow from the liquid supply source 101 toward the reservoir portion 120. When the on-off valve 140 is closed, the flow of liquid from the liquid supply source 101 toward the reservoir portion 120 is blocked.

The on-off valve 140 may be, for example, a solenoid valve configured to open and close the valve by a solenoid, or a motor-operated valve configured to open and close the valve by an electric motor. The on-off valve 140 may be a fluid pressure valve configured to open and close the valve by a fluid pressure cylinder, or may be another type of control valve.

The pressure mechanism 150 is configured to apply a negative pressure to the interior of the reservoir portion 120 from the exterior. The pressure mechanism 150 may be configured to apply a negative pressure to the interior of the reservoir portion 120 via the flexible member 121. In this case, the pressure mechanism 150 displaces the flexible member 121 to increase the volume of the reservoir portion 120 in order to apply a negative pressure to the interior of the reservoir portion 120 from the exterior.

The pressure mechanism 150 of the present embodiment inflates the bag body 122 to increase the volume of the reservoir portion 120 by depressurizing the outside of the reservoir portion 120. When the bag body 122 is inflated, the pressure inside the reservoir portion 120 is reduced. In this manner, the pressure mechanism 150 applies a negative pressure to the interior of the reservoir portion 120 from the outside of the reservoir portion 120. The pressure mechanism 150 may be configured to apply a negative pressure to the interior of the reservoir portion 120 from the exterior by displacing the flexible member 121 by using a mechanical element such as a spring or a lever.

The pressure mechanism 150 may include an accommodation body 152 having a pressure chamber 151 configured to accommodate the reservoir portion 120, and a pump 153 for depressurizing the interior of the pressure chamber 151. The pressure mechanism 150 depressurizes the interior of the pressure chamber 151 by using the pump 153, thereby applying a negative pressure to the interior of the reservoir portion 120 from the exterior. When the pressure inside the pressure chamber 151 is reduced, the bag body 122 is inflated. As a result, a negative pressure is applied from the outside of the reservoir portion 120 to the interior of the reservoir portion 120. The inflated bag body 122 makes contact with an inner wall 154 of the accommodation body 152 forming the pressure chamber 151. When the reservoir portion 120 stores a predetermined amount or more than a predetermined amount of liquid, the flexible member 121 forming the bag body 122 comes into contact with the inner wall 154.

The pressure mechanism 150 of the present embodiment can also pressurize the interior of the pressure chamber 151. When the interior of the pressure chamber 151 is pressurized, the bag body 122 is deflated. The pressure mechanism 150 adjusts the pressure inside the reservoir portion 120 by depressurizing and pressurizing the interior of the pressure chamber 151. The pressure mechanism 150 may be configured to open the pressure chamber 151 to the atmosphere.

The pressure mechanism 150 may include a pressure adjustment flow path 155 connecting the pressure chamber 151 and the pump 153 located outside the accommodation body 152. The pump 153 pressurizes or depressurizes the pressure chamber 151 through the pressure adjustment flow path 155. The pump 153 may be located inside the accommodation body 152.

The liquid ejecting apparatus 10 includes a discharge mechanism 50 configured to depressurize the liquid supply flow path 110. The discharge mechanism 50 is configured to discharge a liquid in the liquid supply flow path 110 from the liquid ejecting portion 41 side relative to the reservoir portion 120 in the liquid supply flow path 110 by depressurizing the liquid supply flow path 110.

The discharge mechanism 50 of the present embodiment includes a cap 51 capable of covering the nozzle 44 of the liquid ejecting portion 41, and a suction pump 52 for sucking stuff inside the cap 51. The cap 51 is brought into contact with the liquid ejecting portion 41, thereby capping the liquid ejecting portion 41. The capping is to form a space in which the nozzle 44 opens. The capping is performed to suppress drying of the nozzle 44, or the like.

When the suction pump 52 is driven while the cap 51 capping the liquid ejecting portion 41, a negative pressure is applied to the nozzle 44 so that the liquid is forcibly discharged through the nozzle 44. This is called suction cleaning. In other words, the discharge mechanism 50 of the present embodiment depressurizes the liquid supply flow path 110 through the liquid ejecting portion 41 so as to discharge the liquid in the liquid supply flow path 110 from the liquid ejecting portion 41.

When the suction cleaning is performed, bubbles, foreign objects, and the like within the liquid ejecting portion 41 and the liquid supply flow path 110 are discharged together with the liquid. Therefore, the discharge mechanism 50 depressurizes the liquid supply flow path 110 in order to maintain the liquid ejecting apparatus 10.

The discharge mechanism 50 may include a waste liquid tank 53 for collecting the waste liquid discharged from the liquid ejecting portion 41. With this, for example, the waste liquid discharged to the cap 51 by the suction cleaning may be collected by the waste liquid tank 53. The waste liquid tank 53 may directly collect the discharged waste liquid.

The discharge mechanism 50 may include a regulator 54 for adjusting the pressure inside the cap 51. The regulator 54 allows the interior of the cap 51 to communicated with the atmosphere so that the pressure in the cap 51 is set to a predetermined pressure, for example, −2 kPa to +2 kPa at the capping time. That is, the regulator 54 adjusts the pressure in the cap 51 to a predetermined pressure by introducing air into the cap 51. The regulator 54 may be an open air valve which is closed when a negative pressure is applied to the nozzle 44, and opened when the interior of the cap 51 is allowed to communicate with the atmosphere.

The liquid ejecting apparatus 10 is configured to perform a maintenance operation in which the liquid supply flow path 110 is depressurized by the discharge mechanism 50 while the liquid supply flow path 110 being closed by the on-off valve 140. When the liquid supply flow path 110 is depressurized by the discharge mechanism 50 in a state where the liquid supply flow path 110 is closed by the on-off valve 140, a negative pressure is accumulated in a portion of the liquid supply flow path 110 downstream of the on-off valve 140. When the negative pressure is accumulated in the liquid supply flow path 110, the volume of the bubble in the liquid supply flow path 110 is increased. As a result, the bubbles in the liquid supply flow path 110 are likely to be discharged.

In the present embodiment, the liquid is discharged through the nozzle 44 by opening the on-off valve 140 in a state where the negative pressure is accumulated in the liquid supply flow path 110. As described above, the operation in which a negative pressure generated by the discharge mechanism 50 depressurizing the liquid supply flow path 110 is accumulated first, and then the liquid in the liquid supply flow path 110 is vigorously discharged through the nozzle 44 by the accumulated negative pressure, is generally referred to as choke cleaning. The choke cleaning is performed to maintain the liquid ejecting apparatus 10. When the choke cleaning is performed, bubbles, foreign objects, and the like in the liquid ejecting portion 41 and in the liquid supply flow path 110 are discharged together with the liquid. The choke cleaning is performed mainly for discharging the bubbles, foreign objects, and the like in the liquid supply flow path 110.

In the liquid ejecting apparatus 10 of the present embodiment, when the choke cleaning is to be performed, the on-off valve 140 is closed first. Subsequently, the liquid supply flow path 110 is depressurized from the liquid ejecting portion 41 side by the discharge mechanism 50. With this, a negative pressure is accumulated in a portion of the liquid supply flow path 110 closer to the liquid ejecting portion 41 relative to the on-off valve 140, that is, in a portion of the liquid supply flow path 110 downstream of the on-off valve 140. Next, the on-off valve 140 is opened. As a result, the liquid is vigorously discharged through the nozzle 44 by the depressurization of the discharge mechanism 50.

In the maintenance operation, when the liquid supply flow path 110 is depressurized by the discharge mechanism 50 in a state where the liquid supply flow path 110 is closed by the on-off valve 140, the reservoir portion 120 is also depressurized. When a negative pressure is applied to the interior of the reservoir portion 120 by the depressurization of the discharge mechanism 50, the liquid flows out of the reservoir portion 120 in some cases. In this case, the liquid stored in the reservoir portion 120 is discharged in order to discharge bubbles, foreign objects, and the like within the liquid supply flow path 110. Therefore, the amount of liquid consumption involved in the maintenance is increased.

When the liquid flows out of the reservoir portion 120 by the depressurization of the discharge mechanism 50, a negative pressure is unlikely to be accumulated in the liquid supply flow path 110. In particular, in the case where the reservoir portion 120 is formed by the flexible member 121, the flexible member 121 is displaced so that the volume of the reservoir portion 120 becomes smaller when the depressurization by the discharge mechanism 50 is applied to the interior of the reservoir portion 120. In this case, when it is attempted to accumulate a sufficient negative pressure in the liquid supply flow path 110, most of the liquid in the reservoir portion 120 flows out resulting from the displacement of the flexible member 121. In other words, in the case where the choke cleaning is performed in such a state, since most of the liquid stored in the reservoir portion 120 is discharged, the amount of consumption of the liquid is likely to become large.

The liquid ejecting apparatus 10 operates in such a manner as to reduce the amount of liquid consumption in the maintenance operation. In the maintenance operation, the control portion 60 controls the pressure mechanism 150 so that a negative pressure equal to or larger than a negative pressure applied to the interior of the reservoir portion 120 by the depressurization of the discharge mechanism 50 is applied to the interior of the reservoir portion 120. At this time, the negative pressure applied to the interior of the reservoir portion 120 by the depressurization of the discharge mechanism 50 is, for example, −50 kPa with respect to the atmospheric pressure. In the maintenance operation, the control portion 60 controls the pressure mechanism 150 so that a negative pressure of −60 kPa, for example, is applied to the interior of the reservoir portion 120 as a negative pressure equal to or larger than −50 kPa. In other words, the pressure mechanism 150 acts to apply a pressure which is smaller than the pressure applied to the interior of the reservoir portion 120 by the depressurization of the discharge mechanism 50, to the interior of the reservoir portion 120 from the exterior. This reduces a risk that the liquid flows out of the reservoir portion 120 due to the depressurization of the discharge mechanism 50.

In the maintenance operation, the pressure mechanism 150 of the present embodiment acts to apply a negative pressure to the interior of the reservoir portion 120 from the exterior in such a manner that the flexible member 121 is not displaced by the depressurization of the discharge mechanism 50. For example, the pressure mechanism 150 depressurizes the pressure chamber 151 in such a manner that the flexible member 121 makes contact with the inner wall 154 of the accommodation body 152 in the maintenance operation. With this, in the maintenance operation, the amount of liquid stored in the reservoir portion 120 may be maintained at a level of a predetermined amount or more than a predetermined amount.

The pressure mechanism 150 pressurizes the interior of the reservoir portion 120 by sending a gas to the pressure chamber 151 when the empty reservoir portion 120 is to be filled with the liquid. When the interior of the reservoir portion 120 is pressurized, the air within the reservoir portion 120 is discharged. This makes it possible for the reservoir portion 120 to be filled with the liquid. The pressure mechanism 150 operates in such a manner that, when the amount of liquid in the liquid supply source 101 becomes small, the liquid is supplied from the reservoir portion 120 by starting to pressurize the interior of the reservoir portion 120.

Next, an example of an operation procedure of a maintenance method for the maintenance of the liquid ejecting apparatus 10 will be described.

In the maintenance operation, after the liquid supply flow path 110 is closed by the on-off valve 140, the liquid supply flow path 110 may be depressurized by the discharge mechanism 50 in a state where a negative pressure is applied to the interior of the reservoir portion 120. For example, the control portion 60 may control the operations in such a manner that a negative pressure is applied to the interior of the reservoir portion 120 by the pressure mechanism 150 and then the liquid supply flow path 110 is depressurized by the discharge mechanism 50. This makes it possible to reduce the risk that the liquid flows out of the reservoir portion 120 due to the depressurization of the discharge mechanism 50.

In the maintenance operation, after the liquid supply flow path 110 is closed by the on-off valve 140, a negative pressure may be applied to the interior of the reservoir portion 120, and then the on-off valve 140 may be opened in a state where the liquid supply flow path 110 is depressurized by the discharge mechanism 50. For example, the control portion 60 may control the operations in such a manner that a negative pressure is applied to the interior of the reservoir portion 120 by the pressure mechanism 150 first, then the liquid supply flow path 110 is depressurized by the discharge mechanism 50, and thereafter the on-off valve 140 is opened. This makes it possible to vigorously discharge the liquid in the liquid supply flow path 110.

Next, the liquid supply device 100 of the present embodiment will be described.

The liquid supply device 100 may include a liquid supply source holding portion 102 for holding the liquid supply source 101 serving as a liquid supply source to the liquid ejecting portion 41. It is sufficient that the liquid supply source 101 is configured to be capable of storing a liquid, and the liquid supply source 101 may be, for example, a replaceable cartridge type or a tank type capable of replenishing the liquid. The liquid supply source 101 is so provided as to correspond to the number of liquid types used by the liquid ejecting apparatus 10.

The liquid supply flow path 110 of the present embodiment includes a first liquid flow path 111 and a second liquid flow path 112. The first liquid flow path 111 connects the liquid supply source 101 and the reservoir portion 120. The second liquid flow path 112 connects the reservoir portion 120 and the liquid ejecting portion 41. The first liquid flow path 111 and the second liquid flow path 112 are connected to the connection body 123 of the reservoir portion 120.

It is sufficient for the liquid supply flow path 110 to be a flow path capable of flowing a liquid therethrough. The liquid supply flow path 110 may be formed of, for example, an elastically deformable tube, or may be formed of a flow-path forming member made of a hard resin material. The liquid supply flow path 110 may be formed by pasting a film member on a flow-path forming member in which a groove is formed.

The liquid supply device 100 may include a pressurization mechanism 170 configured to pressurize a liquid toward the liquid ejecting portion 41. The pressurization mechanism 170 is provided in the liquid supply flow path 110. The pressurization mechanism 170 is located between the liquid supply source 101 and the reservoir portion 120 in the liquid supply flow path 110. Therefore, the pressurization mechanism 170 of the present embodiment is provided in the first liquid flow path 111. The liquid in the liquid supply source 101 is supplied to the liquid ejecting portion 41 via the reservoir portion 120 by the pressurization mechanism 170.

The pressurization mechanism 170 of the present embodiment includes a volume pump 171, a first valve 172, and a second valve 173. The first valve 172 is located upstream of the volume pump 171 in the liquid supply flow path 110. The second valve 173 is located downstream of the volume pump 171 in the liquid supply flow path 110. The first valve 172 and the second valve 173 of the present embodiment are one-way valves that allow the liquid flow from the upstream to the downstream, and restrict the liquid flow from the downstream to the upstream in the liquid supply flow path 110. Similarly to the on-off valve 140, the first valve 172 and the second valve 173 may be configured to open and close the liquid supply flow path 110.

The volume pump 171 is configured to apply pressure to a liquid by reciprocating a flexible film 174 having flexibility. The volume pump 171 includes a pump chamber 175 and a negative pressure chamber 176 that are separated by the flexible film 174. The volume pump 171 includes a depressurization portion 177 for depressurizing the negative pressure chamber 176, and a pressing member 178 for pressing the flexible film 174 toward the pump chamber 175 side. The pressing member 178 is provided in the negative pressure chamber 176.

When the depressurization portion 177 depressurizes the negative pressure chamber 176, the flexible film 174 is displaced so that the volume of the pump chamber 175 becomes larger. At this time, a liquid is drawn from the liquid supply source 101 into the pump chamber 175. When the depressurization of the negative pressure chamber 176 by the depressurization portion 177 is stopped, the flexible film 174 is pressed by the pressing member 178, whereby the flexible film 174 is displaced so that the volume of the pump chamber 175 is reduced. At this time, the liquid is pushed out from the pump chamber 175. That is, the volume pump 171 of the present embodiment is constituted by a diaphragm pump. The volume pump 171 may be constituted by a tube pump.

The pressurization mechanism 170 pressurizes the liquid by the pressing member 178 pressing the liquid in the pump chamber 175 via the flexible film 174. With this, the pressurization mechanism 170 supplies the liquid toward the liquid ejecting portion 41. A pressurizing force of the pressurization mechanism 170 for pressurizing the liquid is set by a pressing force of the pressing member 178.

The liquid supply device 100 may be configured to supply the liquid from the liquid supply source 101 to the liquid ejecting portion 41 by utilizing a water head difference. In this case, the pressurization mechanism 170 may not be provided.

The liquid supply device 100 may include a first filter portion 210, a second filter portion 220, a third filter portion 230, a static mixer 250, a liquid reservoir portion 260, a degassing mechanism 270, and a hydraulic pressure adjustment mechanism 280. The first filter portion 210, the second filter portion 220, the third filter portion 230, the static mixer 250, the liquid reservoir portion 260, the degassing mechanism 270, and the hydraulic pressure adjustment mechanism 280 are provided in the liquid supply flow path 110, and are located between the reservoir portion 120 and the liquid ejecting portion 41. In the present embodiment, the first filter portion 210, the static mixer 250, the liquid reservoir portion 260, the degassing mechanism 270, the second filter portion 220, the hydraulic pressure adjustment mechanism 280, and the third filter portion 230 are disposed in that order from the upstream in the second liquid flow path 112.

In the first filter portion 210, the second filter portion 220, and the third filter portion 230, the foreign objects having been collected increase as the time of use increases. For this reason, the liquid ejecting apparatus 10 may be configured such that at least one of the first filter portion 210, the second filter portion 220, and the third filter portion 230 is replaceable. For example, as illustrated in FIG. 2, the first filter portion 210 may be disposed at a position exposed from the housing 12 when a cover 18 of the housing 12 is opened.

As illustrated in FIG. 3, the first filter portion 210 includes a first filter 211 for collecting foreign objects, a first upstream filter chamber 212 positioned upstream of the first filter 211, and a first downstream filter chamber 213 positioned downstream of the first filter 211. The first upstream filter chamber 212 is positioned on a lower side relative to the first downstream filter chamber 213. The first upstream filter chamber 212 is provided being formed in a substantially conical shape or a substantially truncated conical shape. The first filter 211 is formed in a substantially disk shape to form a bottom surface of the first upstream filter chamber 212. The height of the first upstream filter chamber 212 may be smaller than the diameter of the first filter 211.

The second filter portion 220 includes a second filter 221 for collecting foreign objects, a second upstream filter chamber 222 positioned upstream of the second filter 221, and a second downstream filter chamber 223 positioned downstream of the second filter 221.

The third filter portion 230 includes a third filter 231 for collecting foreign objects, a third upstream filter chamber 232 positioned upstream of the third filter 231, and a third downstream filter chamber 233 positioned downstream of the third filter 231.

The first filter 211, the second filter 221, and the third filter 231 may be formed such that a filtration area through which the liquid can pass is larger than a flow path cross-section area of the liquid supply flow path 110. As the first filter 211, the second filter 221 and the third filter 231, for example, a mesh-formed member, a porous member, a perforated plate having fine through-holes formed therein, and the like may be used. As the first filter 211, the second filter 221 and the third filter 231, filters of different types and different shapes may be used.

Examples of the filter of the mesh-formed member include a wire mesh, a resin mesh, a mesh filter, and a metal fiber. Examples of the filter of the metal fiber include a felt filter in which thin stainless steel wires are made in a felt form, and a metal-sintered filter in which thin stainless steel wires are compressed and sintered. Examples of the filter of the perforated plate include an electroforming metal filter, an electron beam-processed metal filter, and a laser beam-processed metal filter.

The static mixer 250 has a plurality of configurations for dividing a flow of a liquid in a direction in which the liquid flows. The static mixer 250 is configured to divide, change, or reverse the flow of the liquid flowing in the static mixer 250, thereby reducing unevenness of the concentration in the liquid.

The liquid reservoir portion 260 includes a pressurization chamber 261 for storing a liquid, an elastic film 262 forming part of a wall surface of the pressurization chamber 261, and a first pressing member 263 for pressing the elastic film 262 in a direction in which the volume of the pressurization chamber 261 is reduced. The liquid stored in the pressurization chamber 261 is pressurized by the first pressing member 263.

The liquid reservoir portion 260 pressurizes the liquid stored in the pressurization chamber 261 at a pressure lower than a pressure at which the liquid is pressurized by the pressurization mechanism 170 when the liquid is supplied to the liquid ejecting portion 41. The pressure at which the liquid is pressurized by the pressurization mechanism 170 when the liquid is supplied to the liquid ejecting portion 41 is, for example, 30 kPa. Therefore, the liquid reservoir portion 260 pressurizes the liquid stored in the pressurization chamber 261 at, for example, 10 kPa. Specifically, the pressure applied to the liquid stored in the pressurization chamber 261 by the elastic film 262 being pressed by the first pressing member 263 is lower than the pressure applied by the pressurization mechanism 170 to supply the liquid from the liquid supply source 101 toward the liquid ejecting portion 41. Because of this, in the case where the supply pressure of the liquid from the liquid supply source 101 has not been lowered until the arrival at the liquid reservoir portion 260, the elastic film 262 is displaced in a direction in which the volume of the pressurization chamber 261 is increased against the pressing force of the first pressing member 263.

The degassing mechanism 270 includes a degassing chamber 271 for temporarily storing a liquid, an exhaust chamber 273 separated from the degassing chamber 271 by a degassing film 272, and an exhaust path 274 for allowing the exhaust chamber 273 to communicate with the exterior.

The degassing film 272 has a property of allowing a gas to pass therethrough but not allowing a liquid to pass therethrough. As the degassing film 272, for example, a film formed in the following manner may be employed: a large number of fine pores of about 0.2 microns in size are formed in a film that is produced by subjecting polytetrafluoroethylene to a special stretching process, thereby achieving the film for the degassing use. When a liquid containing a gas flows into the degassing chamber 271, only the gas passes through the degassing film 272 and enters into the exhaust chamber 273. The gas that has entered the exhaust chamber 273 is discharged to the exterior through the exhaust path 274. Thus, bubbles and dissolved gases that are mixed in the liquid stored in the degassing chamber 271 are removed.

In the degassing mechanism 270, the exhaust chamber 273 may be positioned above the degassing chamber 271. Bubbles and dissolved gases mixed in a liquid are likely to float in the liquid. Therefore, in the case where the exhaust chamber 273 is positioned above the degassing chamber 271, the bubbles and dissolved gases that are mixed in the liquid are likely to be removed.

The degassing mechanism 270 may include a depressurization pump 275 for depressurizing the exhaust chamber 273. The depressurization pump 275 depressurizes the exhaust chamber 273 through the exhaust path 274 to remove the bubbles and dissolved gases that are mixed in the liquid stored in the degassing chamber 271. For example, in a case where it is possible to make the pressure in the exhaust chamber 273 lower than the pressure in the degassing chamber 271 by using a member such as a spring, the depressurization pump 275 may not be provided. In this embodiment, the pressurization of the pressurization mechanism 170 causes the pressure in the degassing chamber 271 to be higher than the pressure in the exhaust chamber 273.

The hydraulic pressure adjustment mechanism 280 of the present embodiment is provided integrally with the second filter portion 220 at a location downstream of the second filter portion 220. The hydraulic pressure adjustment mechanism 280 includes a liquid chamber 282 communicating with the second downstream filter chamber 223 through a communication hole 281, and a valve body 283 capable of opening and closing the communication hole 281. The hydraulic pressure adjustment mechanism 280 includes a pressure receiving member 284 whose base end side is accommodated in the second downstream filter chamber 223 and whose leading end side is accommodated in the liquid chamber 282.

The liquid chamber 282 of the hydraulic pressure adjustment mechanism 280 is capable of storing a liquid. Part of a wall surface of the liquid chamber 282 is formed by a flexible wall 285 that can be deflected and displaced. The valve body 283 may be an elastic body such as rubber or resin attached to the base end portion of the pressure receiving member 284 located in the second downstream filter chamber 223.

The hydraulic pressure adjustment mechanism 280 includes a second pressing member 286 accommodated in the second downstream filter chamber 223, and a third pressing member 287 accommodated in the liquid chamber 282. The second pressing member 286 presses the valve body 283 in a direction in which the communication hole 281 is closed via the pressure receiving member 284. The third pressing member 287 pushes back the pressure receiving member 284 when the flexible wall 285 pushes the pressure receiving member 284 by the flexible wall 285 being deflected and displaced in a direction in which the volume of the liquid chamber 282 is reduced.

Due to a drop in the internal pressure of the liquid chamber 282, when the force of the flexible wall 285 pushing the pressure receiving member 284 exceeds the pressing force of the second pressing member 286 and the third pressing member 287, the valve body 283 opens the communication hole 281. When the liquid flows into the liquid chamber 282 from the second downstream filter chamber 223 by the communication hole 281 being opened, the internal pressure of the liquid chamber 282 is raised. As a result, before the internal pressure of the liquid chamber 282 rises up to a positive pressure, the valve body 283 closes the communication hole 281 by the pressing force of the second pressing member 286 and the third pressing member 287. In this manner, the internal pressure of the liquid chamber 282 is maintained within a negative pressure range corresponding to the pressing force of the second pressing member 286 and the third pressing member 287.

The internal pressure of the liquid chamber 282 drops along with the discharge of the liquid from the liquid ejecting portion 41. The valve body 283 autonomously opens and closes the communication hole 281 in accordance with a difference in pressure between the atmospheric pressure, which is an external pressure of the liquid chamber 282, and the internal pressure of the liquid chamber 282. Therefore, the hydraulic pressure adjustment mechanism 280 is a differential pressure regulating valve. The differential pressure regulating valve is also referred to as a pressure reducing valve or a self-sealing valve.

A valve opening mechanism 290 configured to forcibly open the communication hole 281 to supply the liquid to the liquid ejecting portion 41 may be added to the hydraulic pressure adjustment mechanism 280. For example, the valve opening mechanism 290 includes a pressurization bag 292 accommodated in an accommodation chamber 291 separated from the liquid chamber 282 by the flexible wall 285, and a pressurization flow path 293 for allowing a gas to flow into the pressurization bag 292.

The pressurization bag 292 is expanded by the gas flowing thereinto through the pressurization flow path 293, and the flexible wall 285 is deflected and displaced in a direction in which the volume of the liquid chamber 282 is reduced, whereby the valve opening mechanism 290 forcibly opens the communication hole 281. The liquid supply device 100 can perform pressure cleaning in which a liquid is flowed out from the liquid ejecting portion 41, by pressurizing and supplying the liquid from the liquid supply source 101 to the liquid ejecting portion 41 in a state where the communication hole 281 is opened.

In the case where the liquid supply device 100 is provided with the depressurization pump 275, the depressurization pump 275 may be shared by the valve opening mechanism 290 and the degassing mechanism 270. For example, the pressurization flow path 293 may be connected to the exhaust path 274, and the depressurization pump 275 may be configured to be capable of both pressurization driving and depressurization driving. In this case, a check valve 187 may be provided in the exhaust path 274. In such a configuration, the depressurization pump 275 may perform the pressurization driving to send the gas to the pressurization bag 292, or the depressurization pump 275 may perform the depressurization driving to depressurize the exhaust chamber 273.

Next, the reservoir portion 120 and the pressure mechanism 150 will be described.

The reservoir portion 120 is so provided as to correspond to the number of liquid supply sources 101. In other words, the reservoir portion 120 is so provided as to correspond to the number of liquid types used by the liquid ejecting apparatus 10. For example, one reservoir portion 120 may be provided corresponding to one liquid supply source 101, or two reservoir portions 120 may be provided corresponding to one liquid supply source 101.

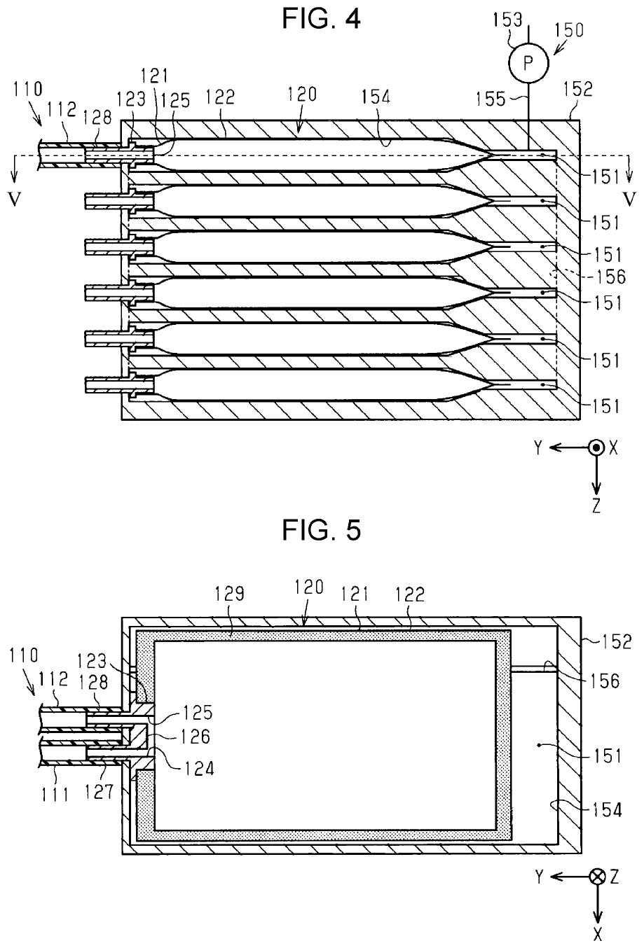

As illustrated in FIG. 4, in the present embodiment, a plurality of reservoir portions 120 is provided. The accommodation body 152 of the pressure mechanism 150 includes a plurality of pressure chambers 151. Because of this, the accommodation body 152 is configured to accommodate the plurality of reservoir portions 120. The accommodation body 152 may be configured to include one pressure chamber 151. In this case, a plurality of accommodation bodies 152 is provided to correspond to the plurality of reservoir portions 120.

In the accommodation body 152, the plurality of pressure chambers 151 is positioned to be aligned in a vertical direction. The accommodation body 152 of the present embodiment includes six pressure chambers 151. Therefore, the accommodation body 152 is configured to accommodate six reservoir portions 120.

The plurality of pressure chambers 151 is configured in such a manner that respective spaces are connected to each other by a slit 156 provided in the accommodation body 152. Therefore, when the pump 153 depressurizes one pressure chamber 151, the other pressure chambers 151 are also depressurized. When the pump 153 pressurizes one pressure chamber 151, the other pressure chambers 151 are also pressurized. The pressure mechanism 150 may include a pump 153 for each pressure chamber 151. In this case, the pressure can be adjusted for each of the pressure chambers 151. The pressure mechanism 150 pressurizes the interior of the reservoir portion 120 by the pump 153 sending a gas to the pressure chamber 151 of the accommodation body 152, and applies a negative pressure to the interior of the reservoir portion 120 by the pump 153 discharging the gas from the pressure chamber 151 of the accommodation body 152.

The inner wall 154 of the accommodation body 152 forming the pressure chamber 151 may be arranged to be in contact with the flexible member 121 that is displaced so that the volume of the reservoir portion 120 is increased. This makes it possible to suppress excessive displacement of the flexible member 121. That is, it is possible to suppress an excessive inflation of the bag body 122. Accordingly, damage to the flexible member 121 due to the excessive displacement may be reduced.

As illustrated in FIG. 5, the reservoir portion 120 may include an introduction hole 124 for introducing a liquid into the reservoir portion 120 and a lead-out hole 125 for leading out the liquid to the outside of the reservoir portion 120. The introduction hole 124 and the lead-out hole 125 of the present embodiment are provided in the connection body 123, and are opened in the bag body 122. The liquid introduced through the introduction hole 124 is led out of the lead-out hole 125 through the interior of the reservoir portion 120.

The connection body 123 may have a connection path 126 connecting the introduction hole 124 and the lead-out hole 125. With this, even in a state where the bag body 122 is completely deflated, the liquid can flow from the introduction hole 124 to the lead-out hole 125 through the connection path 126.

The reservoir portion 120 may include an introduction pipe 127 connected to the first liquid flow path 111, and a lead-out pipe 128 connected to the second liquid flow path 112. The introduction pipe 127 and the lead-out pipe 128 of the present embodiment are provided in the connection body 123. The introduction hole 124 is opened to one end of the introduction pipe 127. The lead-out hole 125 is opened to one end of the lead-out pipe 128. The introduction pipe 127 and the lead-out pipe 128 may be provided independently.

The bag body 122 may be formed by bonding two flexible members 121. The flexible member 121 is provided, for example, as a rectangular sheet. An edge portion of the flexible member 121 is referred to as a bonding portion 129 where the flexible members 121 are bonded to each other. The flexible member 121 may be bonded by an adhesive agent, or may be welded by heat or solvent. The connection body 123 is positioned in such a manner as to be pinched by the bonding portion 129, and is bonded to the bonding portion 129.

In this embodiment, the flat-shaped bag body 122 is disposed taking a horizontal posture to be flat on a plane along the X-axis and the Y-axis. The bag body 122 may be disposed taking a vertical posture to be flat on a plane along the Y-axis and the Z-axis, or may be disposed taking a vertical posture to be flat on a plane along the Z-axis and the X-axis.

Next, operations and effects of the above embodiment will be described.

1. The liquid ejecting apparatus 10 is provided with the control portion 60 configured to control the pressure mechanism 150 to apply, to the interior of the reservoir portion 120, a negative pressure equal to or larger than a negative pressure applied to the interior of the reservoir portion 120 by the depressurization of the discharge mechanism 50 in the maintenance operation in which the liquid supply flow path 110 is depressurized by the discharge mechanism 50 while the liquid supply flow path 110 being closed by the on-off valve 140.

When the liquid supply flow path 110 is depressurized by the discharge mechanism 50 in a state where the liquid supply flow path 110 is closed by the on-off valve 140, a portion of the liquid supply flow path 110 closer to the liquid ejecting portion 41 relative to the on-off valve 140 is depressurized. When the on-off valve 140 is opened in this state, bubbles, foreign objects, and the like in the liquid supply flow path 110 are discharged together with liquid.

When the liquid supply flow path 110 is depressurized by the discharge mechanism 50 in the state where the liquid supply flow path 110 is closed by the on-off valve 140, the reservoir portion 120 is also depressurized. When a negative pressure is applied to the interior of the reservoir portion 120 by the depressurization of the discharge mechanism 50, the liquid flows out of the reservoir portion 120 in some cases. In this case, the liquid stored in the reservoir portion 120 is discharged in order to discharge bubbles, foreign objects, and the like within the liquid supply flow path 110. Therefore, the amount of liquid consumption involved in the maintenance is increased. In this regard, according to the above-described embodiment, in the maintenance operation, the control portion 60 controls the pressure mechanism 150 to apply, to the interior of the reservoir portion 120, a negative pressure equal to or larger than a negative pressure applied to the interior of the reservoir portion 120 by the depressurization of the discharge mechanism 50. This reduces a risk that the liquid flows out of the reservoir portion 120 due to the negative pressure applied to the interior of the reservoir portion 120 from the exterior by the pressure mechanism 150 when the discharge mechanism 50 depressurizes the liquid supply flow path 110. Thus, the amount of liquid consumption involved in the maintenance may be reduced.

2. The pressure mechanism 150 is configured to apply a negative pressure to the interior of the reservoir portion 120 via the flexible member 121. This makes it possible to effectively apply a negative pressure to the interior of the reservoir portion 120.

3. The pressure mechanism 150 includes the accommodation body 152 having the pressure chamber 151 configured to accommodate the reservoir portion 120, and the pump 153 configured to depressurize the interior of the pressure chamber 151. With this, the pump 153 depressurizes the interior of the pressure chamber 151, so that a negative pressure is applied to the interior of the reservoir portion 120 from the exterior. This makes it possible to effectively apply a negative pressure to the interior of the reservoir portion 120.

4. The inner wall 154 of the accommodation body 152 forming the pressure chamber 151 is so disposed as to come into contact with the flexible member 121 of the reservoir portion 120 when the pressure mechanism 150 applies, to the interior of the reservoir portion 120, a negative pressure equal to or larger than a negative pressure applied to the interior of the reservoir portion 120 by the depressurization of the discharge mechanism 50. When the pressure mechanism 150 applies, to the interior of the reservoir portion 120, a negative pressure equal to or larger than a negative pressure applied to the interior of the reservoir portion 120 by the depressurization of the discharge mechanism 50, the flexible member 121 is displaced in such a manner as to increase the volume of the reservoir portion 120. At this time, according to the above-described embodiment, the flexible member 121 having been displaced to increase the volume of the reservoir portion 120 is brought into contact with the inner wall 154 of the accommodation body 152. This suppresses excessive displacement of the flexible member 121, by the negative pressure applied by the pressure mechanism 150. Accordingly, damage to the flexible member 121 due to the excessive displacement may be reduced.

5. In the maintenance operation, after the liquid supply flow path 110 is closed by the on-off valve 140, the liquid supply flow path 110 is depressurized by the discharge mechanism 50 in a state where a negative pressure is applied to the interior of the reservoir portion 120. This makes it possible to reduce the risk that the liquid flows out of the reservoir portion 120 by the depressurization of the discharge mechanism 50.

6. In the maintenance operation, after the liquid supply flow path 110 is closed by the on-off valve 140, a negative pressure is applied to the interior of the reservoir portion 120, and then the on-off valve 140 is opened in a state where the liquid supply flow path 110 is depressurized by the discharge mechanism 50. This makes it possible to vigorously discharge the liquid in the liquid supply flow path 110. As a result, bubbles, foreign objects, and the like in the liquid supply flow path 110 can be effectively discharged.

The present embodiment may be modified and implemented as follows. The present embodiment and the following modifications may be implemented in combination with each other within a range where no technical contradiction exists.

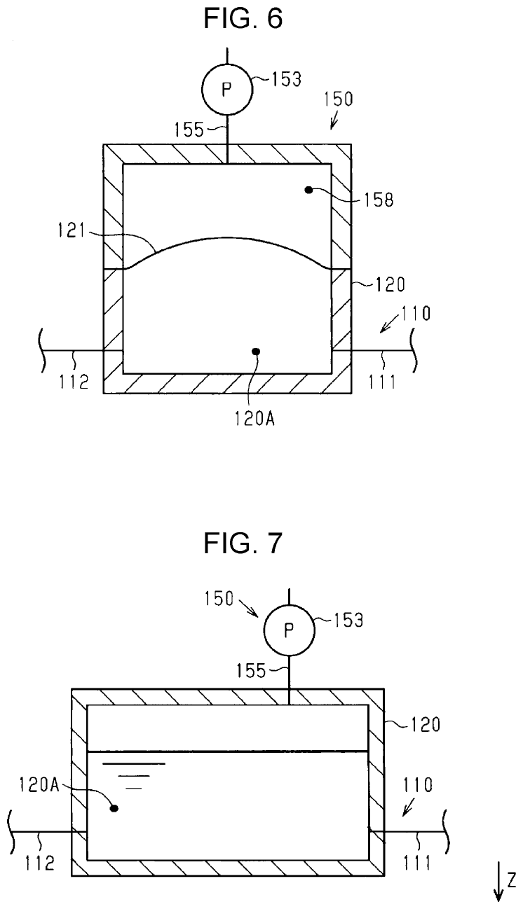

As illustrated in FIG. 6, a reservoir portion 120 may be configured such that part of its wall is formed by a flexible member 121. The reservoir portion 120 includes a reservoir chamber 120A for storing a liquid. A pressure mechanism 150 includes a pump 153, a pressure adjustment chamber 158 positioned adjacent to the reservoir chamber 120A across the flexible member 121, and a pressure adjustment flow path 155 connecting the pump 153 and the pressure adjustment chamber 158.

When the pump 153 discharges a gas from the pressure adjustment chamber 158, the flexible member 121 is so displaced as to increase the volume of the reservoir portion 120. In this manner, the pressure mechanism 150 applies a negative pressure to the interior of the reservoir portion 120 via the flexible member 121. When the pump 153 sends a gas to the pressure adjustment chamber 158, the flexible member 121 is so displaced as to reduce the volume of the reservoir portion 120. In this manner, the pressure mechanism 150 pressurizes the interior of the reservoir portion 120.

As illustrated in FIG. 7, a reservoir portion 120 may not be formed by a flexible member 121. The reservoir portion 120 may be configured as a case having rigidity, for example. The reservoir portion 120 includes a reservoir chamber 120A for storing a liquid. The reservoir portion 120 stores an amount of liquid smaller than the maximum amount of liquid that can be stored. Therefore, there are a region in which a liquid is present and a region in which a gas is present in the reservoir chamber 120A.

The pressure mechanism 150 includes a pump 153 positioned outside the reservoir portion 120, and a pressure adjustment flow path 155 connecting the pump 153 and the reservoir chamber 120A. The pressure adjustment flow path 155 communicates with a space on the upper side in the reservoir chamber 120A. That is, the pressure adjustment flow path 155 communicates with the region where a gas is present in the reservoir chamber 120A. When the pump 153 discharges the gas from the reservoir chamber 120A, a negative pressure is applied to the interior of the reservoir portion 120. In this manner, the pressure mechanism 150 applies a negative pressure to the interior of the reservoir portion 120 from the exterior. When the pressure mechanism 150 sends a gas to the reservoir chamber 120A, the interior of the reservoir portion 120 is pressurized.

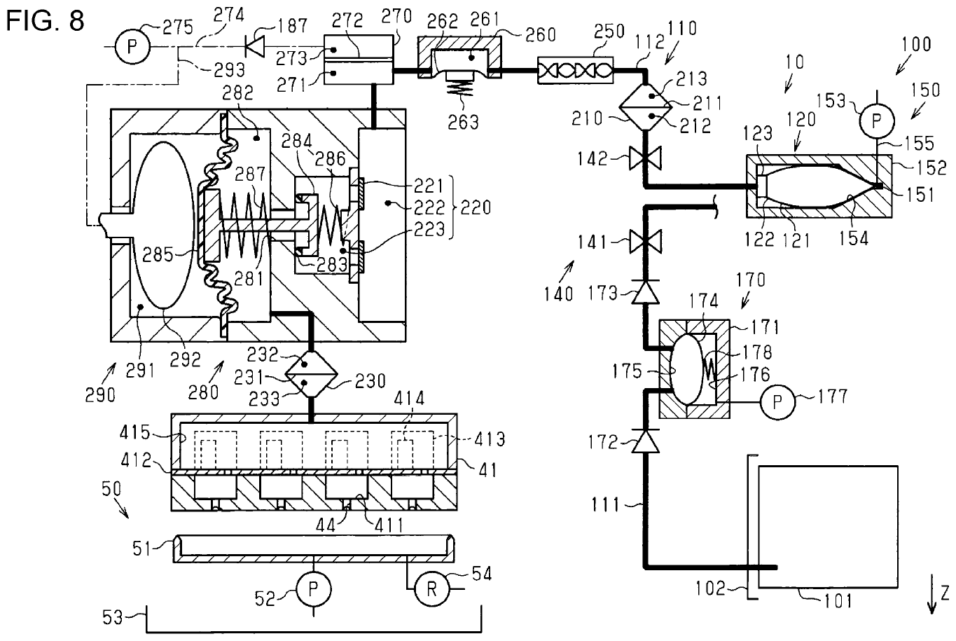

As illustrated in FIG. 8, a liquid ejecting apparatus 10 may include a plurality of on-off valves 140. In a case where the on-off valve 140 that is positioned closer to a liquid supply source 101 relative to a reservoir portion 120 in a liquid supply flow path 110 is a first on-off valve 141, the liquid ejecting apparatus 10 may be provided with a second on-off valve 142 as the on-off valve 140 at a position closer to the liquid ejecting portion 41 relative to the reservoir portion 120 in the liquid supply flow path 110. In this case, when the choke cleaning is performed in a state where the second on-off valve 142 is closed, the risk that the liquid flows out of the reservoir portion 120 involved in the maintenance is reduced. When the liquid in the reservoir portion 120 is to be discharged, the choke cleaning may be performed in a state where the first on-off valve 141 is closed and the second on-off valve 142 is opened.

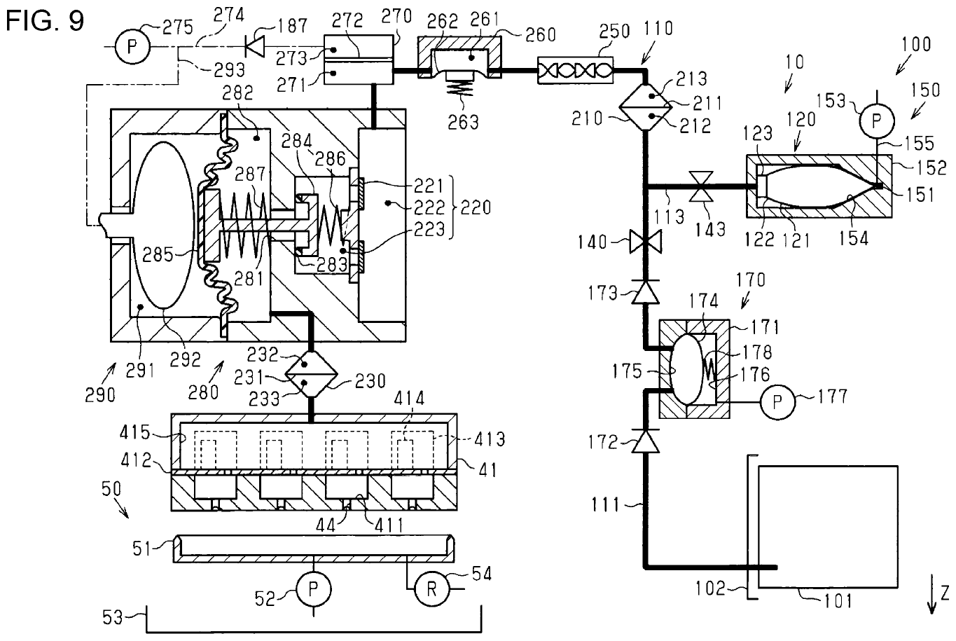

As illustrated in FIG. 9, a reservoir portion 120 may be connected to a liquid supply flow path 110 through one opening. In other words, the reservoir portion 120 may be configured to include a single opening serving as both an introduction hole 124 and a lead-out hole 125. In this case, the liquid supply flow path 110 includes a reservoir-portion flow path 113 extending from a position between an on-off valve 140 and a first filter portion 210 toward the reservoir portion 120.

The liquid ejecting apparatus 10 may include a reservoir-portion on-off valve 143 configured to open and close the reservoir-portion flow path 113. When the choke cleaning is performed in a state where the reservoir-portion on-off valve 143 is closed, the risk that the liquid flows from the reservoir portion 120 involved in the maintenance is reduced. When the liquid in the reservoir portion 120 is to be discharged, the choke cleaning may be performed in a state where the on-off valve 140 is closed and the reservoir-portion on-off valve 143 is opened.

The liquid ejecting apparatus 10 may be configured to perform the choke cleaning in a state in which a pressure chamber 151 is opened to the atmosphere. When the choke cleaning is performed in the state in which the pressure chamber 151 is opened to the atmosphere, bubbles, foreign objects, and the like in the reservoir portion 120 may be discharged.

A pressure mechanism 150 may apply a negative pressure to the interior of the reservoir portion 120 in such cases that the liquid ejecting apparatus 10 is printing and that the liquid ejecting apparatus 10 is in a standby mode, in addition to the maintenance time. For example, the pressure mechanism 150 may apply a negative pressure to the interior of the reservoir portion 120 so that the amount of liquid stored in the reservoir portion 120 is maintained at a level of a predetermined amount or more than a predetermined amount. In other words, the pressure mechanism 150 may depressurize the interior of the pressure chamber 151 so that a bag body 122 is maintained to be in contact with an inner wall 154 of an accommodation body 152. This makes it possible to supply the liquid from a liquid supply source 101 toward a liquid ejecting portion 41 while maintaining the amount of liquid stored in the reservoir portion 120 at a level of the predetermined amount or more than the predetermined amount.

The reservoir portion 120 may be mounted in the carriage 43.

The bag body 122 may be formed by a sheet of flexible member 121.

The medium M may be a metal film, a plastic film, a cloth, or the like.

A liquid ejected by the liquid ejecting portion 41 is not limited to ink, and may be, for example, a liquid material obtained by dispersing or mixing particles of a functional material in a liquid. For example, the liquid ejecting portion 41 may eject a liquid material containing a material such as an electrode material or a pixel material used for the manufacture of liquid crystal displays, electroluminescence displays and surface-emitting displays, or the like in the form of dispersion or dissolution.

Technical ideas and operational advantages understood from the above-described embodiment and modifications will be described below.

A liquid ejecting apparatus includes a liquid ejecting portion configured to eject a liquid through a nozzle; a liquid supply flow path configured to supply the liquid stored in a liquid supply source to the liquid ejecting portion; a reservoir portion provided in the liquid supply flow path and configured to store the liquid; an on-off valve provided on a side of the liquid supply source relative to the reservoir portion in the liquid supply flow path and configured to open and close the liquid supply flow path; a discharge mechanism configured to discharge the liquid in the liquid supply flow path from a side of the liquid ejecting portion relative to the reservoir portion in the liquid supply flow path by depressurizing the liquid supply flow path; a pressure mechanism configured to apply a negative pressure to an interior of the reservoir portion from exterior; and a control portion configured to control the pressure mechanism to apply, to the interior of the reservoir portion, a negative pressure equal to or larger than a negative pressure applied to the interior of the reservoir portion by the depressurization of the discharge mechanism in a maintenance operation in which the liquid supply flow path is depressurized by the discharge mechanism while the liquid supply flow path being closed by the on-off valve.

When the liquid supply flow path is depressurized by the discharge mechanism in a state where the liquid supply flow path is closed by the on-off valve, a portion of the liquid supply flow path closer to the liquid ejecting portion relative to the on-off valve is depressurized. When the on-off valve is opened in this state, bubbles, foreign objects, and the like in the liquid supply flow path are discharged together with the liquid.

When the liquid supply flow path is depressurized by the discharge mechanism in the state where the liquid supply flow path is closed by the on-off valve, the reservoir portion is also depressurized. When the negative pressure is applied to the interior of the reservoir portion by the depressurization of the discharge mechanism, the liquid flows out of the reservoir portion in some cases. In this case, the liquid stored in the reservoir portion is discharged in order to discharge bubbles, foreign objects, and the like in the liquid supply flow path. Therefore, the amount of liquid consumption involved in the maintenance is increased. In this regard, according to the above configuration, in the maintenance operation, the control portion controls the pressure mechanism to apply, to the interior of the reservoir portion, a negative pressure equal to or larger than a negative pressure applied to the interior of the reservoir portion by the depressurization of the discharge mechanism. With this, a risk that the liquid flows out of the reservoir portion is reduced by the negative pressure that is applied to the interior of the reservoir portion from the exterior by the pressure mechanism, when the discharge mechanism depressurizes the liquid supply flow path. Thus, the amount of liquid consumption involved in the maintenance may be reduced.

In the liquid ejecting apparatus, the reservoir portion may be formed of a flexible member, and the pressure mechanism may be configured to apply a negative pressure to the interior of the reservoir portion via the flexible member.

According to this configuration, a negative pressure may be effectively applied to the interior of the reservoir portion.

In the liquid ejecting apparatus, the pressure mechanism may include an accommodation body having a pressure chamber configured to accommodate the reservoir portion, and a pump configured to depressurize the interior of the pressure chamber.

According to this structure, a negative pressure is applied to the interior of the reservoir portion from the exterior by the pump depressurizing the interior of the pressure chamber. Therefore, the negative pressure may be effectively applied to the interior of the reservoir portion.

In the liquid ejecting apparatus, the inner wall of the accommodation body forming the pressure chamber may be so disposed as to come into contact with the flexible member of the reservoir portion when the pressure mechanism applies, to the interior of the reservoir portion, a negative pressure equal to or larger than a negative pressure applied to the interior of the reservoir portion by the depressurization of the discharge mechanism.

When the pressure mechanism applies, to the interior of the reservoir portion, the negative pressure equal to or larger than the negative pressure applied to the interior of the reservoir portion by the depressurization of the discharge mechanism, the flexible member is displaced in such a manner as to increase the volume of the reservoir portion. At this time, according to the above structure, the flexible member having been displaced to increase the volume of the reservoir portion is brought into contact with the inner wall of the accommodation body. This suppresses excessive displacement of the flexible member, by the negative pressure applied by the pressure mechanism. Accordingly, damage to the flexible member due to the excessive displacement may be reduced.

A maintenance method for a liquid ejecting apparatus includes a liquid ejecting portion configured to eject a liquid through a nozzle; a liquid supply flow path configured to supply the liquid stored in a liquid supply source to the liquid ejecting portion; a reservoir portion provided in the liquid supply flow path and configured to store the liquid; an on-off valve provided on a side of the liquid supply source relative to the reservoir portion in the liquid supply flow path and configured to open and close the liquid supply flow path; and a discharge mechanism configured to discharge the liquid in the liquid supply flow path from a side of the liquid ejecting portion relative to the reservoir portion in the liquid supply flow path by depressurizing the liquid supply flow path. The method includes applying, to an interior of the reservoir portion, a negative pressure equal to or larger than a negative pressure applied to the interior of the reservoir portion by the depressurization of the discharge mechanism in a maintenance operation in which the liquid supply flow path is depressurized by the discharge mechanism while the liquid supply flow path being closed by the on-off valve.

According to this method, the same effects as the above liquid ejecting apparatus may be obtained.

In the maintenance method for the liquid ejecting apparatus, in the maintenance operation, after the liquid supply flow path is closed by the on-off valve, the liquid supply flow path may be depressurized by the discharge mechanism in a state where a negative pressure is applied to the interior of the reservoir portion.

According to this method, it is possible to reduce the risk that the liquid flows out of the reservoir portion by the depressurization of the discharge mechanism.

In the maintenance method for the liquid ejecting apparatus, in the maintenance operation, after the liquid supply flow path is closed by the on-off valve, a negative pressure may be applied to the interior of the reservoir portion, and then the on-off valve may be opened in a state where the liquid supply flow path is depressurized by the discharge mechanism.

According to this method, it is possible to vigorously discharge the liquid in the liquid supply flow path. As a result, bubbles, foreign objects, and the like in the liquid supply flow path may be effectively discharged.

What is claimed is:

1. A liquid ejecting apparatus comprising:
a liquid ejecting portion configured to eject a liquid through a nozzle;
a liquid supply flow path configured to supply the liquid stored in a liquid supply source to the liquid ejecting portion;
a reservoir portion provided in the liquid supply flow path and configured to store the liquid;
an on-off valve provided on a side of the liquid supply source relative to the reservoir portion in the liquid supply flow path and configured to open and close the liquid supply flow path;
a discharge mechanism configured to discharge the liquid in the liquid supply flow path from a side of the liquid ejecting portion relative to the reservoir portion in the liquid supply flow path by depressurizing the liquid supply flow path;
a pressure mechanism configured to apply a negative pressure to an interior of the reservoir portion from exterior; and
a control portion configured to control the pressure mechanism to apply, to the interior of the reservoir portion, a negative pressure equal to or larger than a negative pressure applied to the interior of the reservoir portion by the depressurization of the discharge mechanism in a maintenance operation in which the liquid supply flow path is depressurized by the discharge mechanism while the liquid supply flow path being closed by the on-off valve.

2. The liquid ejecting apparatus according to claim 1, wherein
the reservoir portion is formed of a flexible member, and
the pressure mechanism is configured to apply a negative pressure to the interior of the reservoir portion via the flexible member.

3. The liquid ejecting apparatus according to claim 2, wherein
the pressure mechanism includes an accommodation body having a pressure chamber configured to accommodate the reservoir portion, and
a pump configured to depressurize an interior of the pressure chamber.

4. The liquid ejecting apparatus according to claim 3, wherein an inner wall of the accommodation body forming the pressure chamber is so disposed as to come into contact with the flexible member of the reservoir portion when the pressure mechanism applies, to the interior of the reservoir portion, a negative pressure equal to or larger than a negative pressure applied to the interior of the reservoir portion by the depressurization of the discharge mechanism.

5. A maintenance method for a liquid ejecting apparatus provided with
a liquid ejecting portion configured to eject a liquid through a nozzle,
a liquid supply flow path configured to supply the liquid stored in a liquid supply source to the liquid ejecting portion,
a reservoir portion provided in the liquid supply flow path and configured to store the liquid,
an on-off valve provided on a side of the liquid supply source relative to the reservoir portion in the liquid supply flow path and configured to open and close the liquid supply flow path, and
a discharge mechanism configured to discharge the liquid in the liquid supply flow path from a side of the liquid ejecting portion relative to the reservoir portion in the liquid supply flow path by depressurizing the liquid supply flow path, the method comprising:
applying, to an interior of the reservoir portion, a negative pressure equal to or larger than a negative pressure applied to the interior of the reservoir portion by the depressurization of the discharge mechanism in a maintenance operation in which the liquid supply flow path is depressurized by the discharge mechanism while the liquid supply flow path being closed by the on-off valve.

6. The maintenance method for the liquid ejecting apparatus according to claim 5, wherein, in the maintenance operation, after the liquid supply flow path is closed by the on-off valve, the liquid supply flow path is depressurized by the discharge mechanism in a state where a negative pressure is applied to the interior of the reservoir portion.

7. The maintenance method for the liquid ejecting apparatus according to claim 6, wherein, in the maintenance operation, after the liquid supply flow path is closed by the on-off valve, a negative pressure is applied to the interior of the reservoir portion, and then the on-off valve is opened in a state where the liquid supply flow path is depressurized by the discharge mechanism.
